(19) United States
(12) Patent Application Publication
(10) Pub. No.: US 2006/0047780 A1
(43) Pub. Date: Mar. 2, 2006

(54) Method and apparatus for web-based, schema-driven application-server and client-interface package using a generalized, data-object format and asynchronous communication methods without the use of a markup language.

(75) Inventor: Gregory Philip Patnude, Hayden, ID (US)

Correspondence Address: Mr.Gregory Philip Patnude, 3059 East Garwood Road, Hayden, ID, 83835, US

(73) Assignee: Gregory Philip Patnude, Hayden, ID (US)

(21) Appl. No.: 11/164,051

(22) Filed: Nov. 8, 2005

(51) Int. Cl. G06F 15/16

(52) U.S. Cl. 709/219; 709/203

(57) ABSTRACT

Web-based applications provide an alternative approach to client-server computing using the internet or intranet as the transport mechanism. The invention uses the schema and system catalogs of a relational database to contain and describe the methods, features, functions, and operation of a web-based application. In the invention, a generalized object format is used to minimize bandwidth consumption and substantially improve system performance. Data is converted to and from this generalized object format by both the application server and by the client-side view controller. Formatting of the generalized data object does not rely on or use any form of markup language, markup tags, or DTD's. Transmission of the generalized data object occurs asynchronously over the internet.

The present invention provides a method to retrieve, serialize, and encrypt data and data object(s) from a centralized data source and application server, transmit the data object(s) asynchronously via an internet or network connection to a client computer, to decrypt and render the data object(s) for visual display or remote-client processing, to encrypt and communicate data changes into a serialized data object, to transmit the encrypted object back to the application server using asynchronous methods, to decrypt the serialized object(s) and restructure the object(s) into a storable format, and to persistently store the reconstructed data in a centralized data source on the application server, and vice-versa without the use of any markup language.

### BACKGROUND OF THE INVENTION

The following are generally well known and accepted as fact:
(1) That object oriented programming reflects the “current state of the art” in applications programming.
(2) That the techniques of object-oriented programming are well established.
(3) That relational database systems or RDBMS's are known to exist.
(4) That most RDBMS's support or conform to published ANSI SQL standards and that SQL-based databases and the tables and structures contained therein are well known in the art.
(5) That RDBMS's utilize various methods of data-typing and store data type information internally as a schema or in system catalogs.
(6) That the HTTP and HTTPS transport protocols are established internet communication technologies.
(7) That client-server programming using object-oriented techniques and Model-View-Controller (MVC) paradigms are an established and viable approach to developing application software.
(8) The process of interrogation of a relational database schema or catalogs to obtain information pertaining to the database tables and the interrelationships between database tables is a well known practice.
(9) That the use of Internet, Intranet, or other network to communicate from a database computer to a server computer to a client computer is a well known and established practice.
(10) That the use of software to manually map database tuples (rows of a table or, more importantly, multiple rows of related tables) into objects for use by object oriented languages such as lava and C++ is a well known practice.
(11) That the use of software to map objects from relations and data in relational database management systems or vice versa to object oriented applications is also well known.
(12) That the use of software to transmit information in object form from a server computer to a client computer or vice-versa is a well known practice.
(13) That high-level programming languages that support object-oriented programming techniques and practices contain internal data structures, methods, and variables is well known.
(14) That in the object-oriented paradigm, various languages use a fairly consistent approach to data types, and that data types can be cast, coerced, or otherwise converted from one type to another is well known.
(15) That programming-language dependent objects, arrays, and variables can be converted, mapped, or otherwise coerced into a language-independent format is generally understood in the expert-level community but not widely practiced.
(16) That language-specific objects can be serialized or de-serialized is generally well known.
(17) That markup-languages such as UML, SGML, HTML and XML encoding are published standards and widely used as descriptors or wrappers to transmit information or data via the internet is a widely adopted and well known practice.
(18) That the XMLHTTPRequest mechanism is an asynchronous communication mechanism using the internet backbone as a transfer medium is relatively well known.
(19) That the XMLHTTPRequest mechanism is not required to utilize XML encoding is not very well known outside of the expert-level developer community.
(20) That most modern internet browser software supports and executes embedded scripting languages and scripted instructions in various forms, including VBScript, JavaScript, and ECMA-262 compliant languages is a well known fact and widely used as a client-side technology on the internet.
(21) That an object-oriented approach to client-side scripting can be implemented in the client-side browser is not well known to the general population but is generally well known in the expert-level developer community.

### SUMMARY OF THE INVENTION

This invention provides a complete approach for implementing an AJAX-style programming model, including: design, development, data delivery, formatting, input, output, storage, and deployment of web-based applications. This invention provides both an application-server and an application-client environment in which to develop and deploy web-based applications over the internet, intranet, or network. Both components are necessary for operation of the invention. The two major components are:
An application-server using any relational database and its associated software components; and
An application-client package or view controller, and its associated software components.

By extending current object-oriented programming techniques, using a database schema-driven system and a modified version of the MVC (Model-View-Controller) paradigm, we describe a complete methodology and platform specification that:
Serializes and de-serializes data or data objects into a platform neutral format.
Uses and transfers serialized, encrypted, and generalized data objects via the internet or TCP/IP network and the XMLHTTPRequest mechanism.
Describes and implements an application framework and provides a design pattern or programming methodology for rapid application development and deployment (RAD).
Implements a robust, schema-based data model and persistence layer.
Implements and enforces business rules and work or process flows.
Provides an application server platform for the delivery and deployment of web-based application software.
Implements and enforces granular security and access controls.
Incorporates a platform-neutral client side view controller system.
Is generally 60 to 100 times faster than the current internet computing model.
Uses less than 5% of the bandwidth currently required for deployment of web-based applications.

The invention is designed to provide a rapid application development (RAD) platform, RDBMS storage mechanism, information and data delivery mechanism(s), and a client-interface package for the development and deployment of web-based applications using a generalized object format. The application client package communicates with the application server asynchronously using the XMLHTTPRequest mechanism of communication over the internet or network.

The preferred embodiment of the present invention is also disclosed in the following Principles of Operation.

### BRIEF DESCRIPTION OF THE DRAWINGS

FIG. 1 illustrates the general operation of an Asynchronous Client-Server System, showing the data flows and communications between the client and server.

FIG. 2 illustrates the general internal functions and processes of the Application Server.

FIG. 3 illustrates the general internal functions and processes of the Application Client.

FIG. 4 provides an illustrated example of the generalized object format utilized by the Asynchronous Client-Server System.

### PRINCIPLES OF OPERATION

This document provides, for reference purposes, a detailed definition of the application server (Server) and client-interface (View) product, support classes, software packages, and scripts that comprise the invention (DEJA).

Built exclusively upon open, generally accepted industry standards, DEJA has successfully addressed several problems associated with distributing web-based applications over the internet. In particular, a generalized and efficient object-oriented mechanism to transfer and deploy relational application data or web-based application content without development of custom software modules and CGI-style scripting has proven elusive. It is these processes and algorithms that are unique to DEJA; thus a detailed description of this technology is an appropriate focus of the present invention.

The result of the above technologies is an object-oriented HTTP Servlet and client-interface software package that use generally accepted industry standard Internet-centric protocols and software engineering standards to develop and deploy web-based applications without the overhead of a markup language and without the overhead of programming or scripting each individual method and function of the application.

Required Background

Outlined herein is the minimum level of insight required to understand and take maximum advantage of DEJA to design, deploy, and to efficiently implement a web-based application server and client controller. The reader is assumed to have:
(1) An advanced working knowledge of relational databases.
(2) Significant development experience with C, C++ or the Java programming language(s) at the expert level.
(3) An expert level understanding of the Java J2EE technologies, including HTTP Servlets and the HTTP query-response mechanisms.
(4) An expert level understanding of the internet, internet or web servers, and the internet transfer protocols and mechanisms, including the XMLHTTPRequest protocol and the HTTP request standards.
(5) An advanced understanding of the theories of object-oriented technology, including: object notation, object serialization, and abstraction or generalization of objects and object-data.
(6) Significant experience in the development and deployment of client-server applications.
   Document Organization

The information presented in this document is grouped into the following sections:
(1) GENERAL OPERATION
(2) APPLICATION SERVER
(3) APPLICATION CLIENT
(4) EXTENSABILITY OF THE APPLICATION FRAMEWORK
(5) ASNCHRONOUS COMMUNICATIONS
(6) RDBMS SCHEMA DESIGN
(7) DETAILED OPERATION
(8) APPLICATION SERVER (Internal Processes)
(9) APPLICATION CLIENT (Internal Processes)
(10) RELATED TECHNOLOGIES
(11) TERMINOLOGY
   1) GENERAL OPERATION

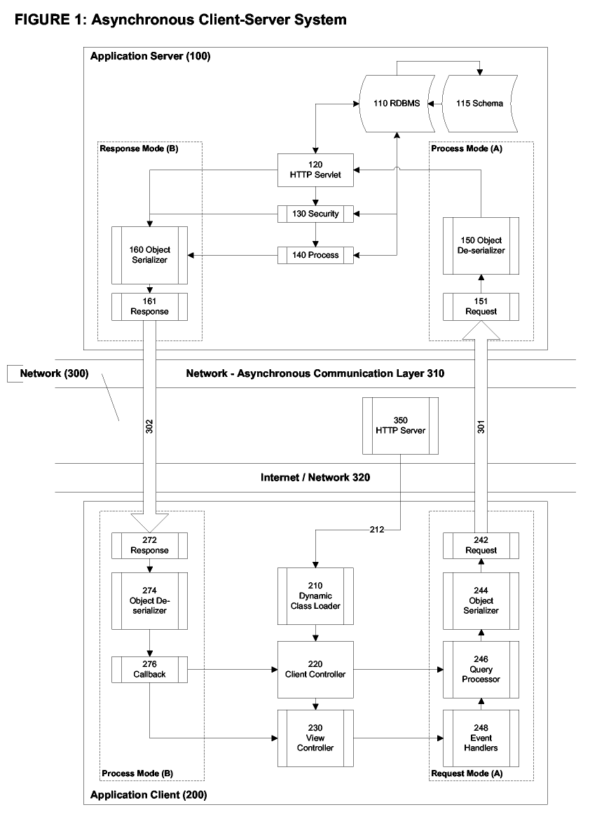

Referring to FIG. 1, a general illustration of the asynchronous web-based client-server system is presented. The present invention is composed of a delivery platform and programming methodology or design pattern approach to develop and deploy web-based applications via the internet and the supporting server and client software necessary to support and implement the invention. The invention consists of two major components:
A platform neutral J2EE-based application server and server-application software (application server or platform) 100.
A platform neutral object-oriented client software package (visual interface or presentation layer) 200.

The Application Server platform is an enterprise solution that delivers high-performance, web-based applications based on an underlying data model or schema. In the design pattern, application development and deployment is as simple as designing a normalized database structure, exposing tables to a client (security settings), and informing the client-interface how to visually render the data structures (configuration settings).

The Application Client 200, requests and receives data object(s) from the Application Server 100, decodes the object, and formats the object for display, editing, or other manipulations as set in the presentation template. When data is changed, the presentation layer automatically communicates changes back to the application server utilizing an asynchronous communication protocol of the internet or network 300 to which it is attached.

The system consists of a platform-neutral Application Server 100, a platform neutral Application Client 200, and a network or internet transport and communications layer 300. The application server 100 includes application software, application code or instructions, a RDBMS 110, and a web server 310.

2) APPLICATION SERVER

The Application Server 100 is a web-based application server that operates as an HTTP Servlet 120. The Application Server may also act as a traditional HTTP web-server (serving HTML 310), as a data server 110, or as an enterprise application server on the internet, intranet, or other network of 300. It should be noted that the application server 100 depicted in this embodiment of the invention is not limited to communications only with the client software package 200 of this invention. The application server 100 responds to any authenticated request using the mechanisms and techniques described herein.

In process mode A, the application server 100:
(1) Receives an incoming client request 151.
(2) De-serializes the client request 150.
(3) Invokes the Application Servlet 120.
(4) The Application Servlet 120, in turn, invokes a connection to the relational database 110 and passes program control to the internal security system 130.

The internal security system of 130 authenticates the client request against a security model and access control system defined in the RDBMS 110, and tracks and logs information about the client request by storing a copy of the incoming request in the database. Upon completion of the security checks and authentication, the security monitor invokes a method or mechanism to process the client request 140.

The process 140 subsequently:
(1) Stores the client submitted data or information in the RDBMS 110.
(2) Executes the client request 140.
(3) Initiates a server response 161 to the client requestor by invoking the Object Serializer 160.

Internally, when the application server 120 finishes processing an incoming client request 150, the application server switches into response mode B, and a signal or an updated data object is returned to the requesting client. In response mode 161, the application server process 140 retrieves, formats, and delivers data or data components retrieved from the data source of 110 using a unique approach to:
(1) Describe the data object including the properties, data types, and internal structures of the database 110 and the underlying database schema 115.
(2) Retrieve the data or data object from the data source 110.
(3) Coerce the data and data objects into a standardized format using the object serializer 160.
(4) Convert the formatted object into a textual representation or generalized object format using a process internal to the object serializer 160.
(5) Transmit the textually represented object 161 to the client requester over the asynchronous transport mechanism of the internet or network 300.
   3) APPLICATION CLIENT

The application client software package 200 consists of cross-platform client code that retrieves and displays data or data components retrieved from the server or responds to instructions or signals received from the application server (100). The client layer communicates asynchronously (301, 302), and in real-time with the application server by sending and receiving a serialized, encrypted data “object” using the XMLHTTPRequest mechanism of the Internet or network 300.

The Application Client 200 layer makes requests upon the application server 100 or receives and processes response codes and data objects transmitted by the application server 201. In request mode A, the application client:
(1) Formats and prepares the security key or security credentials, application data, and request codes to the application server 246.
(2) Initiates an asynchronous client-server communication mechanism 244.
(3) Submits the request to the application server 242.
(4) Allocates or initializes a callback function to listen for the application server's response 276.

In process mode (B), the application client callback function 276 listens for the application server's response. When a response is received by the callback function, the application client:
(1) Captures or retrieves the response data 272.
(2) De-serializes the response data or instructions and converts the data from its textual representation to a native data-object format for further processing by the application client 274.
(3) Uses the re-encoded object, object-data, or instructions 274 to visually render and display the data into a human readable format 230; or
(4) Perform additional processing 220 as determined by the received instructions of the incoming response 272.
   4) EXTENSABILITY OF THE APPLICATION FRAMEWORK

The client layout manager is an integral part of the invention and is necessary to support web-based deployment of applications using the techniques of this invention. The server platform does not necessarily require use of the application client package. Because the application server responds to and processes any authenticated request, additional client interfaces can be developed in other languages to communicate with or use the application server. Additional client interfaces can be built using virtually any object-oriented language provided that (the interface software):
(1) Implements the standards and practices of this invention.
(2) Implements or extends the standard communication protocols used by the application server software.
(3) Utilizes the same or similar request and response processing techniques of the client application interface and the application server.
(4) Implements and adheres to the security controls of the application server.
(5) Provide methods and mechanism that support universal object serialization and de-serialization.
(6) Connects to the application server using the published application programming interface or API of the application server.
(7) The application server is also extensible through the implementation and deployment of external class files, written in the Java programming language. In order to successfully extend the application server:
(8) External class files must be written and compiled in the Java programming language and adhere to the J2EE conventions and standards.
(9) External class files must load or otherwise incorporate their own internal dependencies or libraries.
(10) External class files must implement and adhere to a pre-defined structure as defined in the application server API.
(11) External class files must return a pre-defined Java data type or object.
(12) External class files must be located in a pre-determined file and directory structure under the application server.
(13) External class files must be capable of being dynamically loaded or instanced by the application server's internal dynamic class loading mechanism.
   5) ASNCHRONOUS COMMUNICATIONS

Again, referring to FIG. 1, all client-server (340) and server-client communications (380) takes place using the XMLHTTPRequest mechanism over the widely utilized HTTP(S) transport layer of the internet or network 300. The application server 100 operates as a threaded servlet and responds to all incoming requests. Therefore, the Application Server 100 is not required to utilize asynchronous methods of the XMLHTTPRequest or to implement callback functions to process a client request.

The client view controller 200, however, uses the asynchronous methods of the XMLHTTPRequest 340, to communicate over the network 300 with the application server 100, and therefore, is required to implement callback functions 276 in order to process an incoming server response 380.

6) RDBMS SCHEMA DESIGN

The techniques described within this document are highly dependent on robust normalization and consistency of the machine managed data source. These requirements include:
A standardized naming scheme and methodology for database internals including tables, columns, views, primary keys, foreign keys, lookup tables, and other objects within the RDBMS.
Efficient use and utilization of primary and foreign keys in the RDBMS.
A consistent design methodology and normalization of relations and other objects within the RDBMS.
A consistent methodology for defining and retrieving lookup (picklist) data for embedding of the lookup data into the serialized data object schema at runtime.
Consistent implementation of stored procedures, triggers and rules within the machine managed RDBMS.
Insert, update and delete rules on views defined within the RDBMS.

The schema implementation also relies on:
Consistent use of data types and typecasting.
A highly relational and consistent approach to manipulating, formatting, and processing data structure, including:
   Design.
   Storage.
   Retrieval.
   Inserts/additions.
   Updates/deletes.

The schema system implements, leverages, or extends:
The RDBMS catalogs.
Universal data types.
Type casting from language specific data types to universal types and vice versa.
   7) DETAILED OPERATION

The following sections describe in detail, the internal operations of the invention. It may prove useful to the reader, to refer to the drawings, where referenced in the following sections.

8) APPLICATION SERVER (Internal Processes)

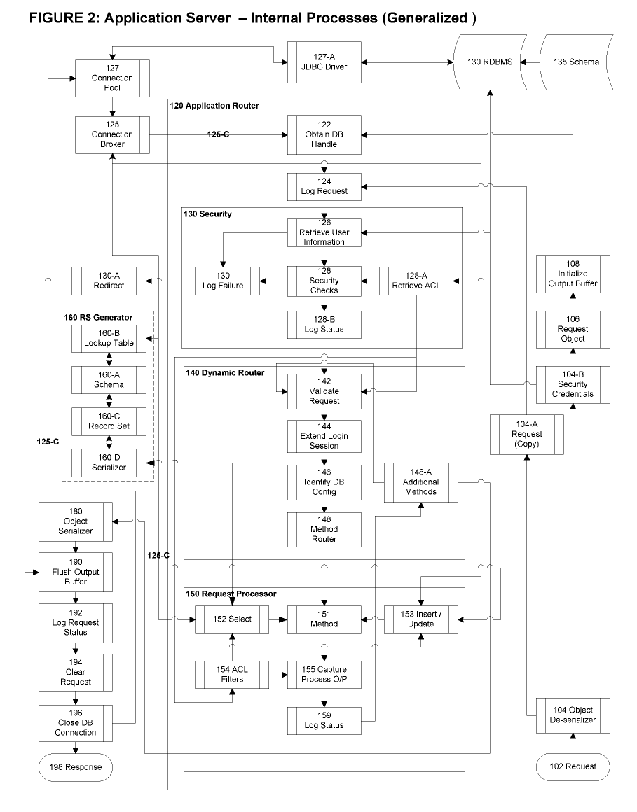

Referring to FIG. 2, which illustrates a generalized perspective of the internal processes of the Application Server (100). A remote client or machine process requests the application server, or an instance of the application server to perform a process, task, execute a computing algorithm, or provide information or instructions back to the requestor.

This process takes place through a network connection or similar communication mechanism through the submission of a request and a client credential or security key to the application server (100). The incoming request is presented to the application server as an HTTP Request object 102. The request object 102 is passed to the internal Object De-serializer 104. Prior to any further processing, the deserializer 104, puts a copy of the original request 102 into an internal storage buffer 104-A and further extracts data from the request, such as security credentials and stores these in 104-B.

The de-serializer 104 reconstructs the incoming request parameters into a native language object, 106. This reconstructed native object will become the basis for all future processing by the Application Server. Once the de-serializer 104 finishes processing the incoming request object 102, the application Servlet initializes and clears the output buffer, 108. The output buffer, 108 now becomes the target object for all response data 198 that will eventually be sent to the requestor.

Program control now passes to the Application Router 120. The first task of obtaining a database connection occurs in 122. This database connection or database handle will be passed through the application router and be used by many of the subsequent or child processes that take place in the Application Server. The database connection 125-C is obtained by 122 from the internal database connection broker 125. The connection broker of 125 leases a database connection from the database connection pool 127.

In the connection broker 125, the connection pool 127, and through the JDBC Driver 127-A, the application server internally manages and maintains persistent connections to both local and/or remote databases and data sources.

The local system database 130, is used to catalog and maintain:
(1) System configuration.
(2) Real-time logs and status information.
(3) Authentication data and security information.
(4) Application configuration and application settings.
(5) Information and connection data for remote database access.
(6) Application data and the application schema 135.

In 122, upon successfully negotiating lease of a database connection (125-C), the database connection is made available to any sub-process required to obtain or store information in the system database 130.

In 124, the next steps in the process chain are to store and log a copy of the original, preserved form of the incoming request 104-A using the database connection 125-C obtained in 122. The logging process of 124 also includes storing the following information:
(1) Date/time of the request.
(2) IP Address of the requestor.
(3) The requested process or method.
(4) Session ID of the requestor.
(5) Other pertinent data, relating to the request.

The processes of 126 are executed to retrieve information about the user. This information will be further used in the security validation process of 128, and may also be used in processes 130, and 130-A.

The security checks of 128 require that an ACL, or access control list be retrieved via process 128-A for the requestor. This ACL is used to:
(1) Verify that the requester has sufficient access rights, privileges, and/or permissions to perform or execute the request
(2) Re-authenticating the credential against the login credential stored in the persistence layer (RDBMS).
(3) Verifying or validating that the security key or credential supplied by the requester is a valid credential.

If the request does not successfully pass the required security checking steps of 128, a failure notice is logged 130, and a re-direct 130-A issued to the requesting client. From the point of failure forward in the process, the application server will not process or provide any information to the requestor other than a re-direction to the login page. To ensure that this process occurs properly, any authentication failure immediately causes:
(1) Program control and execution are passed to 190.
(2) In 190, the output buffers and HTTP Response header are immediately flushed to the requesting client.
(3) In 192, a record is stored in the internal database system using the database connection 125-C indicating failure of the process.
(4) In 194, any pending processes within the instance of the application servlet for the request are cleared.
(5) In 196, the global database connection 125-C is returned to the database connection pool 127 for future re-use by the connection broker.
(6) The response object 198 is passed to the requestor.

If the requester and process request successfully passes the required security checks of 128, any additional logging mechanisms internal to 128, and other internal security mechanisms initiated by the application server, the application server logs status of the security checking operations in 128-B.

Upon completion of the logging steps of 128-B, program control and execution passes to the dynamic request routing system 140. The dynamic routing system initializes storage in the output response mechanism 180 and initiates the process of executing the clients request by:
(1) 142—Analyzing the request and any additional client-supplied data or information required to support the request or aid in determining the exact nature of the request.
(2) 144—Extending the expiration of the current authenticated logon session.
(3) 146—Identifying any special configuration or requirements of the method to be executed.
(4) 148—Dynamically routing the request and client supplied information through a request router mechanism.

The request router mechanism 148 may then dynamically load and instantiate an internal or external class object or set of compiled instructions in order to process the request. The internal processes of 148 may include:
(1) Loading or instantiating an internal static class method or set of pre-compiled instructions in order to process the request.
(2) Spawning additional internal or external processes to execute or otherwise perform the requested operation and initiate or execute the aforementioned process.
(3) 148-A—Looping through additional requests and repeating the process of dynamic request routing for each child request, thus routing child requests through the internal dynamic request processor.
(4) Dynamically determining the appropriate internal software method or mechanism to perform in order to successfully process the request, and initiating the method or mechanism.

(140) At this point in the overall process, the application server, has successfully performed the required security checks, internal logging, and determined the appropriate internal or external method necessary to execute or process the request. Program control now passes to the identified supporting process 150.

A supporting process generally takes the form of the request processor 150. When program control is passed to the request processor, the dynamic request router 140 also passed or otherwise made the initial request, security credentials, security keys, and any supporting or supplied data available to the targeted supporting process. Upon completion of the supporting process, program control, and the output data or result of the process is returned to the request router at point 148-A.

A typical request processor 150, consists of the methods and mechanisms:
(1) 151—A method controller or the method logic necessary to perform the intended operation.
(2) 152—An optional method or mechanism to retrieve a specific record set or set of information from the database.
(3) 153—An optional method or mechanism to insert, update, or otherwise store information in the database based on criteria of the ACL generated in 128-A.
(4) 154—A set of filters, restrictions, or criteria based upon the ACL identified and generated in 128-A used during the retrieval of records to control access.
(5) 155—A method or mechanism to capture output data from the process intended to be later serialized and appended to the output buffer of the client response.
(6) A direct alternative to the raw data of 155 is to perform the conversion of the output data to the generalized object format and directly append the generalized object to the output buffer.

159—Upon notification that the supporting process is completed, the request processor informs the internal logging mechanism that the process or method has been completed. Control of program execution is next returned to point 148-A of the application router, 140.

Upon re-entry to point 148-A, the application router examines the client request to determine if there are additional processes or child requests. In the event of additional processes or child requests to be executed, the process repeats by transferring program control to point 142 of the application router. If there are not further pending requests or processes to be performed, program control is transferred from 148-A to point 180, the object serializer.

180—Prior to reaching the entry point of the object serializer, the application server, request router, and request methods are expected to put any combination of data, instructions, signals, and database records into an output buffer targeted for the requesting client. The object serializer 180 uses a variety of unique internal methods and mechanisms to create a language independent, generalized view of the data to be returned to the requesting client. Data and data objects are serialized by the internal software mechanisms and algorithms of 180 to:
(1) Convert all data destined for transmittal to the process request into a common object format.
(2) Reduce the size and complexity of the data or data object.
(3) Format, reformat, or otherwise coerce the data or data object into a common or generalized format that can be reconstructed by the requesting process or client view controller.

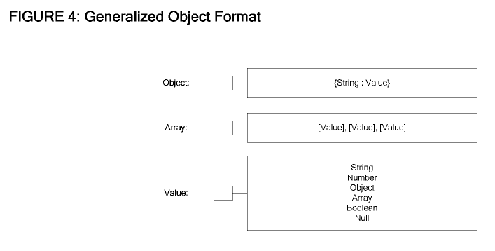

While referring to FIG. 4, it can be seen that data and data object serialization generally occurs through the following mechanisms:
(1) Converting, type casting, or otherwise coercing the data or data object from its native data type into one of the universal data types.
(2) Cleaning or “scrubbing” the data or data object to ensure consistency between the preferred data type and the universal data type for that data object.
(3) Appending the coerced data or data object into a consistent, cross-platform, language independent, decipherable object structure.
(4) Creating a consistent, decipherable, cross-platform, language independent object structure from the data or data object using a standardized object-notation algorithm or format.
(5) Appending serialized data objects into an array or associative array of serialized data objects.
(6) Converting the serialized array or associative array into a textual or string representation of the object.
(7) Typically, a generalized, or serialized data object takes on the “name:value” form of object notation or data representation, where a “name:value” pair can be an:
   array [ ]
   object { }
   array of objects [{ }, { }, { }]
   number value (integer, float, real, signed or unsigned)
   string value (string, text, varchar, char)
   date value (date, time, datetime, timestamp)
   boolean value (true, false, 1, 0)

Again referring back to FIG. 2, upon completion of the data object serialization and object notation conversions identified in the above, and as performed in 180, the serialized, object-notated data structure and program control is appended to the output buffers of the application server in preparation for sending to the client requestor. Program control is now passed to 190.

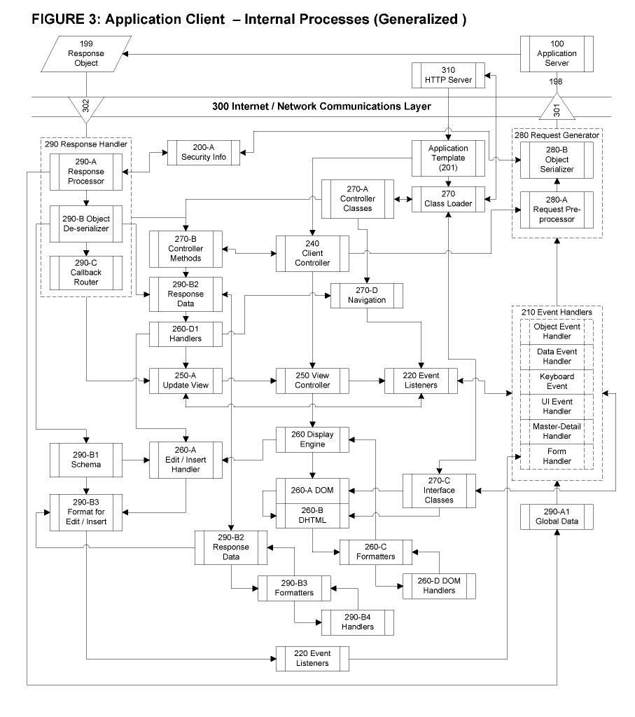

190—The output buffers are flushed to the client requestor. The data on the buffers is transferred over the internet or network as identified in FIG. 1, point 300. The data on the output buffer becomes the HTTP Servlet response object 198 of FIG. 2, and is also referenced in identified FIG. 1 as point 161. This response object (FIG. 1—Point 198) will also be seen by the Application Client as item 199 in FIG. 1 and as item 199 In FIG. 3.

Referring back to FIG. 2, at point 192—the internal logging mechanism updates or captures total execution time of the process and stores a copy of the current session log in the system database.

194—In step 194, the current request being processed is marked as completed. Additionally:
(1) Internal flags and status are updated accordingly.
(2) Server resources are released for re-use.
(3) Program control passes to 196.

In 196—the application server releases the database connection 125-C, and returns it to the connection pool 127 for re-use by the next incoming request.

At point 198 of FIG. 1, the Application Server process is now completed. Program control an execution is reset, and the application server is ready to process the next incoming request.

9) APPLICATION CLIENT (Internal Processes)

While referring to FIG. 3: “Application Client-Internal Processes”, the application client interface or view controller software consists of reusable application code, functions, and instructions necessary to:
(1) Store and manipulate data objects and instructions.
(2) Submit requests to the application server.
(3) Receive responses from the application server.
(4) Serialize and de-serialize application server request and response data.
(5) Visually render data or data objects into a human readable format.
(6) Process the data objects and/or instructions received from an application server.
(7) An application interface template or layout manager.
(8) A dynamic class loader.
(9) A dynamic response router.

The Application Client includes software instructions and application code to render data or data objects for display and responds to application server instructions. This provides the application client with a layout manager to manage, maintain, control, and respond to changes that occur within the user interface, or UI. This layout manager provides the facilities to retrieve, format, and display or process:
(1) Generalized objects.
(2) Numeric data.
(3) Dates and times.
(4) Strings or textual data.
(5) Graphics and images.

The dynamically loaded classes of the application client provides the facilities to visually render:
(1) Drop-down or cascading menus and menu/navigation systems.
(2) Expanding/collapsing trees or hierarchal menus and navigation systems.
(3) Date and calendar choosers and controls.
(4) Drop-down lists, select lists, and list controls.
(5) Checkboxes and radio button controls.
(6) Button and link controls.
(7) Tables, including rows and columnar or tabular data.
(8) Grid or spreadsheet-style controls.
(9) Tab-folders or tabbed panels and controls.
(10) Parent-child, or master-detail relationships between data or data objects.
(11) Field labels, instructions, and information.

Internally, the layout manager includes the code, instructions, and functions necessary to process, perform, or respond to:
(1) Keyboard events and event listeners/handlers.
(2) Mouse events and mouse event listeners/handlers.
(3) Data or object events and event listeners/handlers including the processing of:
(4) Database recordsets.
(5) Data and information.
(6) Schemas and data object descriptors.
(7) Drag and drop events and event listeners/handlers.

This implementation of the layout manager and Application Client software system specifically incorporates:
(1) Calendar and calendar control routines.
(2) Common or core routines.
(3) Date, string, and numeric data manipulation and formatting routines.
(4) DOM/DHTML manipulation routines.
(5) Tree manipulation routines.
(6) Event listener and management routines.
(7) Form processing routines and functions for automatically formatting, updating or saving changes to data or data objects.
(8) Grid and spreadsheet manipulation routines.
(9) Bi-directional asynchronous communication routines.
(10) Object serialization and de-serialization routines.
(11) Layout/template management and manipulation routines.
(12) Menu generation and menu management routines.
(13) Database and data object or recordset parsing and processing routines.
(14) Data schema and formatting routines.
(15) General system utilities.
(16) Tabbed pane or tab-folder manipulation routines.
(17) A dynamic class loader utility to load additional, external routines on-demand.
(18) Routines to control and manipulate the look and feel of the visual interface.
(19) Routines and methods to capture and process debugging information and machine-state information.
(20) A dynamic, context sensitive help system.

While referring to FIG. 3, the following paragraphs describe in detail, the internal processes and operations of the Application Client. Initial assumptions are as follows:
(1) That this instance of the Application Client will operate in a standard web-browser.
(2) That the user has entered the correct HTTP address or URL of the Application Server.
(3) That the reader has a general knowledge of using web browser software to browse or otherwise navigate the internet.

Following the assumptions of the previous paragraph, the application client is initially obtained from the HTTP web-server 310. This process occurs using the standard mechanisms of the internet and synchronous methods of the network 300. The client browser loads and requests an application template 201 from the server.

The application template 201, while loading, immediately requests the dynamic class loader 270 from the web server 310 and a login page containing a form for system login. Prior to the application template completing its loading process, the dynamic class loader makes additional requests on the web server for the set of core libraries or classes required by the Application Client. This additional request on the web server 310 is to obtain:
(1) Class Libraries 270-A.
(2) Controller Methods 270-B.
(3) Interface Classes 270-C.
(4) Communications Handlers 270-D.
(5) Request Generator 280 and its components.
(6) Response Handler 290 and its components.
(7) Event Handlers 210.
(8) Event Listeners 220.

After loading the core components of the Application Client, control passes to the Client Controller 240. The Client Controller serves as the primary interface between:
(1) The View Controller 250 and the Display Engine 260.
(2) The Request Generator 280.
(3) The Response Processor 290.

Program control now passes from the Application Template 201 to the Client Controller 240 to View Controller 250. View Controller 250 instantiates Event Listeners 220 and attaches an event listener to the login form initially loaded by the Application Template 201.

The next immediate process of the Application Client 200 is to authenticate against the security system(s) of the Application Server 100 and to obtain a valid session id and security credentials. The security credentials will be stored as Security Information in 200-A. Following a successful system logon, this security information will be accessed throughout the operation of the Client Application.

To logon to the Application Server, the user fills in their user name and password in the logon form loaded with the Application Template 201, and submits the request to the Application Server 100 through Event Listener 220. Event Listener 220 passes control to the Event Listeners 210, which in turn signal the Request Generator 280.

Within the Request Generator 280, The Request Preprocessor 280-A and Object Serializer 280-B, operate in conjunction to retrieve, format, and serialize the client data to be submitted to the Application Server 200. In the case of logging in to the system, the client data consists of a user name and password.

The Request Pre-processor 280-A and the Object Serializer 280-B perform multiple functions, including, but not limited to:
(1) Retrieving the Application Client data or data object to be submitted as part of the request.
(2) Identifying the Application Server 200 process to be invoked upon the request 301 to be submitted.
(3) Identifying the Application Client language dependent data types that constitute the data or data object.
(4) Converting or casting the data or data object into a suitable data type recognized by the generalized object format
(5) Serializing the generalized object for transmission over the internet or network.
(6) Identifying the Callback Router 290-C to be invoked upon receipt of the Application Server 200's response once the Application Server process is complete.

The Request Generator activates the Callback Router 290-C, and submits the formatted request object 198 to the Application Server over the Internet or Network Communications Layer 300 using an asynchronous communication mechanism 301. The Application Server 100 then performs the action requested by the Application Client and issues a formatted Response Object 199. The Response Object 199 is transmitted to the Application Client over the Internet or Network Communications Layer 300 using the asynchronous communication mechanism 302.

Within the Response Handler 290, the Response Processor 290-A and Object De-Serializer 290-B operate in conjunction to retrieve, de-serialize, and format the incoming response prior to processing by the Callback Router of 290-C. The Response Processor 290-A and Object De-Serializer 290-B perform multiple functions, including but not limited to:
(1) Retrieving the response object transmitted by the Application Server.
(2) Identifying the Application Client language dependent data types that constitute the data or data object.
(3) De-Serializing the generalized object and converting or casting the response data or response object from the generalized object format into a suitable data type recognized by the Application Client.
(4) Storing a copy of the original response object in the Response Data 290-B2. This response data is now selectively available to any other component within the Client Application.

Note that the Response Data object 290-B2 may further rely on the Formatters 290-B3 and Handlers 290-B4 to render data and data objects for display purposes.

During the processing phase of 290-B it is determined that the reconstructed data object is a database recordset, the recordset's schema is also re-constructed and stored in the Schema Object 290-B1. The Schema Object may then be later used for editing or formatting of the recordset, as required.

Once the generalized response object has been prepared and cast into a native object or data format recognized by the Application Client, program control passes to the Callback Router of 290-C. The Callback Router identifies the object type, and target function for further processing or manipulation of the response data and passes control to the identified function in the Controller Methods of 270-B.

The Controller Methods 270-B contains the application logic and instructions necessary to complete processing of the response data. These methods:
(1) Manipulate the View Controller 250 though the Client Controller 240.
(2) The reconstructed data in Response Data container 290-C.
(3) Attach event handlers 260-D1, Edit-insert Handlers 260-A, and Navigational handlers 270-D.
(4) Manipulate the Display Engine 260 through the View Controller 250 and update or redraw the user interface through the mechanisms of 250-A.

The View Controller 250, Display Engine 260, Document Object Model, or DOM 260-A, and DHTML Controller 260-B operate concurrently to provide control over the presentation layer of the Application Client. These mechanisms respond to any or all of the interface events, mouse events, keyboard events, navigation events, and data events assigned to the interface object when it was rendered as generally discussed in the preceding paragraphs.

The Display Engine 260, DOM Controller 260-A and the DHTML Controller 260-B further rely on the Formatters 260-C and DOM Handlers 260-D to render data and data objects for display purposes. Note that the DOM Controller 260-A and the DHTML Controller 260-B may also respond directly to programmatic calls issued by the Interface Classes of 270-C or respond indirectly to programmatic calls issued by any other software component of the Application Client.

The Event Listeners 220 wait for and invoke one or more of the Event Handlers 210 in response to:
(1) Navigation events of 270-D,
(2) Interface events of 220.
(3) Data events of 290-B4.
(4) Keyboard and Mouse events.

The Event Handlers 210 pass control to the Request Generator 280, thus triggering a request 198 on the Application Server and the Client Application processes repeat.

10) RELATED TECHNOLOGIES & KEYWORDS

Related Technologies & Keywords include the following:
HTTP/HTTPS and HTTPD Internet servers
Apache (http://www.apache.org)
Tomcat (http://www.apache.org)
BEA's Weblogic
Sun's Enterprise Application Server (http://java.sun.com)
IBM's Websphere
JBoss (http://www.jboss.com)
Microsoft's IIS (http://www.microsoft.com)
HTTP and HTTPS transfer protocols, W3C standards, Internet standards http://www.w3c.org
XMLHTTPRequest
XML, HTML, UML, SGML, SSL http://www.w3c.org
Relational databases (RDBMS), SQL, ANSI SQL, database schemas and system catalogs, ODBC
Object relational mapping
CORBA (Common Object Request Broker)
RPC (Remote Procedure Calls)
Data types, type conversion, type casting, language objects
Object-oriented languages, Object-oriented programming techniques
HTTP Servlets, application servers, internet or web-servers, client-server computing
Java (http://java.sun.com)
J2EE and J2EE application servers
J2EE Servlets and servlet programming,
JDBC Database connections
JDBC Connection pooling
JNDI
JSON (JavaScript Object Notation) http://www.json.org,
Object “serialization”
AJAX/SAJAX (Asynchronous JavaScript and XML)
www.modernmethod.com
http://www.sajax.com
http://www.ajaxpatterns.org
Object notation and Object-oriented programming in JavaScript (http://www.crockford.com)
The Microsoft “Atlas” project (Google: keywords “Microsoft Atlas”)
Macromedia's Flash Application Server, Flash Remoting http://www.macromedia.com
Web-based applications, Internet, Intranet
Model-View-Controller or the “MVC Paradigm”, MVC-II
   11) ABBREVIATIONS & TERMS

Server

A system composed of hardware, software, communication mechanisms, data transport mechanisms, and operating system software that responds to remote requests, processes received requests, performs additional process, and delivers information, data, or instructions to the requesting system.

Data Source

A persistent layer, application, or file on a web server, database server, or server farm that stores, updates, and retrieves information in the form of key-value pairs, records, or interpretable information in response to a set of instructions. As an example: a machine managed data source could be but is not restricted to one or more of the following:
A JDBC Connection.
An ODBC Connection.
A file handle (csv, txt, dbm).
A JNDI handle.
An IO stream or socket connection.

Record

An abstract block of data in the form of key-value pairs, rows, or other human or machine interpretable data that constitutes information, instructions, or other content.

Record Set

A group of, collection or, or set of records, information, or other human or machine interpretable data, as defined above.

Schema

The metadata or other information usually managed and stored by a data source that describes the structure and data format of a table, row, column, record set, or other data entity within a data source.

Universal Data Type, or UDT

Universal data types are similar to the data types defined in high-level programming languages such as C, C++, and Java with the further understanding that the universal data types are made up of the greatest subset of the typical data types supported by most high level programming languages. As an example: An RDBMS may support integer data types of integer[2], integer[4], and integer[8] where the corresponding UDT would be of type integer[8].

Applications Programming Interface (API)

The platform application server is made accessible to third-party software or additional client-interface packages by providing a server application programming interface or “API”. The API exposes certain methods of the application server and provides a published methodology for creating software interfaces that communicate with, make requests of, and receive or interpret responses from the application server.

It is understood that many variations, modifications, and improvements may be devised given the description of operation and the principles of the invention. It is intended that all such variations modifications, and improvements be considered as within the scope and spirit of this invention.

What is claimed is:

1. An article of manufacture consisting of methods and mechanisms for an asynchronous, bidirectional client-server system used for the development and deployment of web-based applications using a variation of the Model-View-Controller, or MVC paradigm, where
the invention uses a relational database, or RDBMS to store data, which is generally referred to as the “Model”, or “data model”; and
the invention incorporates an object-oriented client software package and source code to manage and manipulate the visual presentation layer, generally referred to as the “View controller”, “client-controller”, or “client-interface”; and
the invention incorporates proprietary, executable application source code for operation as the application server, which functions as the primary interface between the view controller and data model, thus comprising the “Controller” or “application” portion of the MVC paradigm.

2. Wherein the general statements of claim 1, the view controller, or client-interface portion of the invention
uses an object-oriented presentation layer as the primary View Controller; and
contains the client-executable code and instructions necessary for operation as the client-interface to the application server; and
uses the well-known internet transfer protocols such as HTTP and HTTPS and the XMLHttpRequest mechanism for asynchronous communication with the application server; where
the first implementation of the client invention, as stated within these claims, consists of a series of object-oriented class libraries, written in the JavaScript language, thus making the client-controller package platform neutral, and capable of running in the context of a modern web browser software package; and
that future or alternative implementations of the client-controller package may or not be limited to running within the context of the traditional web-based, or internet model.

3. The statements of claim 1, wherein said proprietary software of the application server executes and operates as a web-based application server; and the further of
the server software is written in the Java programming language, thus making it capable of operating or executing on any computer with a Java Virtual Machine; and
the server software executes and operates as an HTTP servlet; and
the server software manages and maintains connections to said database or data model; and
the server software while executing, operates as the application layer, or Controller; and
the invention further uses well-known internet transfer protocols such as HTTP and HTTPS and the XMLHttpRequest mechanism for asynchronous communications with the client-interface; and
further transmits a pure data object over the internet using a generalized object structure without incurring the overhead of HTML, SGML, UML, XML, or any markup languages or tags.

4. Wherein the general methods of claim 3 the invention further comprises the steps of reading an incoming HTTP or HTTPS request or query string, and
logging or storing a copy of the incoming request into a perpetual storage container, or said database; and
further decoding the incoming request from its generalized object format into a language specific object structure and request parameters; and
further performing security checks and validation of the requester or requesting client against an access control list or ACL; and
further determining the nature of the client request and dynamic routing of the decoded request parameters to a series of internal method or process, or to a loadable or external application method or process; and
further encoding the output or response of the application server into a generalized object structure for transmission to the requesting client.

5. The method of claim 4 wherein said decoding of the request further consists of retrieving the incoming HTTP(S) request from the input stream using well known methods and mechanisms of an internet web server, where
the incoming request is formatted as a stringified or serialized version of the generalized data object; and
said conversion or mapping of the serialized version of the generalized data object into a normalized language object consists of several additional steps; and
converting the re-created normalized language object into a parameter list suitable for processing by the application server; and
storing or otherwise preserving and preparing the language dependent object format for additional processing or application of computing methods within the application server namespace.

6. The method of claim 4 wherein said security validation and authentication checks on the request which further comprises the steps of validating the client IP address against an internal listing of IP addresses which are known to be authorized; and
during initial login, performing initial validation of the user against an internal listing of authorized system users by comparing the user supplied account name to the stored account name; and
generating a 32 bit session id or security key and storing it in said database for future reference; and
comparing a user supplied password to an internally stored password; and
comparing the current client IP address, supplied in the HTTP request header to the IP address stored when the client originally logged in to the system; and
validating the 32 bit session id or security key supplied against a previously stored and authenticated session key; and
storing the user credential along with the query string of the request in said RDBMS; and
verifying that the user credential is not expired or invalidated by comparing the security key to a previously stored expiration date and timestamp for the security key; and
further logging the state or status of user authentication into an internal security tracking and request logging table within said RDBMS; and
further generating an internal ACL, or access control list for the validated account or user name or otherwise confirming that the requested process is authorized for the validated user.

7. The method of claim 4 wherein said steps of identifying the nature of the request and dynamic routing of the request consists of the further steps of
querying said database for configuration information related to the request; and
locating or obtaining access to an internal or core method of the application; or
locating, loading, and instantiating an external method; and
further executing the methods of the request; and
further capturing the data output of the method for further processing or eventual transmission to the requester.

8. The method of claim 4 wherein said encoding of the server response object further comprises internal methods and mechanisms for converting a language dependent data structure or object into the generalized data object (the generalized response data object) format for further transmission to the client workstation as a stringified, or serialized form of a name-value pair generally comprising the name:value format, where the value component may be composed of any arrangement of:
an object { }, where an object can contain a further number of embedded objects, arrays, or name-value pairs; or
an array [ ], where an array can contain a further number of embedded objects, embedded arrays, or name-value pairs; or
a string generally comprising the name: “value” format; or
a number generally comprising the name:1.001 format, where a number can represent whole numbers (integers) or a real numbers (floats, real, etc.) in varying mathematical notation; or
a date generally comprising the name: “date” format wherein a date is generally represented in one of many ISO formats, such as timestamp, datetime, or universal-time-code (UTC).

9. An article of manufacture consisting of methods and mechanisms for a schema-based, or database-driven web-based applications technology and application server comprising the steps of
reading said elements of said database and corresponding schema definitional elements to determine values of said elements and their relationships; wherein
said reading step further comprises generating a generalized data object based upon an inversion or translation of said database; and
assembling a list of the values of said elements and their relationship into a generalized view of said database; wherein
the methods and mechanisms for converting and serializing data into a generalized, language independent data-object format (a response object) and vice-versa are identified in claim 8, above;
where the generalized response object is encoded or decoded and formatted according to the methods and structures identified in the prior claims.

10. Where stated in theses methods and claims, the generalized application server output or response object may further comprise any combination of
a generalized schema definition; and
a generalized view of the relational data; and
a generalized set of instructions; and
additional data or identification of additional processes to be invoked by the client.

11. The method of claim 9 wherein said generalized schema definition consists of a method of using information from the RDBMS system catalogs to develop a generalized object schema that describes the format of the generalized data object, where developing the generalized object schema consists of the further steps of
identifying the columns to which the requesting client is allowed access or view based upon the ACL and security authorization of the client, as previously identified in the prior claims; and
identifying the column name from the RDBMS catalogs; and
identifying ANSI SQL data-type of the column from the RDBMS catalogs; and
identifying the universal data type or UDT of the column; and
identifying the field labels or display context of the column, and whether the column is viewable or editable in the requesting client's context; and
identifying whether the column is the primary key or sequence key of the table; and
identifying data integrity constraints, referential integrity constraints, null or not null constraints, and default values of the column.

12. The method of claim 11 wherein said identification as to whether the column is a foreign key reference or lookup table, that, if the column is determined to be a foreign key reference to another table within said RDBMS; and further
retrieving and formatting the lookup data or picklist data for the column into an embedded generalized object format as described in claim 8, above; and
appending the generalized view of the lookup data into the generalized schema generated subsequent to any process of claim 11.

13. The method of claim 4 wherein said conversion of the derived schema into the generalized object format previously identified in claim 8, above, includes preparing and storing the generalized object schema in the application server's output buffer or client response buffer for later transmission to the requestor or for further internal processing.

14. The method of claim 9 wherein said generalized view of relational data consists of the further steps of
dynamically generating SQL constructs to retrieve data from RDBMS table(s) or view(s) identified in the client request; and
dynamically generating SQL constructs or processing limitations to further filter or restrict access to those columns identified as available to the requestor by the ACL generated during the authentication steps of claim 6.

15. The method of claim 4 wherein said dynamic routing of the decoded request further includes
executing the dynamically generated SQL construct or query against the RDBMS to retrieve data; and
capturing the resultant recordset from the SQL query; and
converting or encoding the resultant recordset into the generalized object structure using the processes and methods of claim 8 and the universal data types or UDT's for the tabular data, from the generalized schema generated for the process as identified in claim 10; and
preparing and storing the generalized recordset in the application server's output buffer or client response buffer for later transmission to the requester or for further internal processing.

16. The method of claim 9 wherein said generalized set of instructions may further consist of server requests or information transmitted to the client software application, wherein additional server requests or information may include, but are not limited to
requests to perform or execute a process internal to the client application software; or
requests for the client software application to submit or post additional data to the application server; or
additional instructions or information to the client software package to log out or invalidate the user, to redraw or refresh the user interface, or to perform any other operation available in the client-interface.

17. An article of manufacture consisting of methods and mechanisms to automatically store, insert, or update database records in response to client-submitted requests, wherein,
said storage of client-supplied data further consists of the steps of identifying the target storage table within the RDBMS for the requested storage process; and
confirming that the requestor authenticated during the validation process of claim 6 has appropriate rights and privileges in the ACL to perform the requested operation; and
dynamically generating an SQL statement to perform the insert, update, or deletion of the user-supplied data; and
performing an automatic save of the original, unchanged database record(s) into a virtual rollback system for future recovery or audit; and
executing the dynamically generated SQL statement, thusly performing the requested operation; and
further generating an application server response object indicating completion status and success/failure of the operation.

18. An article of manufacture consisting of methods and mechanisms for a template-driven client view-controller package that allows a client workstation running standard web-browser software to receive the serialized, generalized data object (the response object), wherein
said client-controller further comprises the steps and processes of converting client-side data and data objects into the generalized object format (a request object) supported by the application server and to make requests on, initiate a server process, or to retrieve responses from the application server using the generalized object format, and vice-versa; and
said client-controller includes the methods and mechanisms that utilize the language specific data object or structure for visual rendering, display, or other manipulation on the client-workstation; and
said client-controller includes the methods and mechanisms to encode and decode said generalized data structure(s) to and from the client-request format; and
said client-controller includes the methods and mechanisms to encode and decode said generalized data structure(s) to and from the server-response format; and
said client-controller includes the methods for rendering of the reconstructed data object in various GUI formats; and
said client-controller provides methods and mechanisms that include the ability to edit or otherwise modify the data; and
said client-controller includes the methods and mechanisms for communicating changes to the data object back to the server; and
said client-controller includes the methods and mechanisms for initiating any available server process using the described request object and transfer mechanisms.
